(19) United States
(12) Patent Application Publication
(10) Pub. No.: US 2013/0185139 A1
(43) Pub. Date: Jul. 18, 2013

(54) System, Method and Computer Program Product for Compensating Web Users for Viewing Targeted Ads

(71) Applicant: YOUDATA, INC., Houston, TX (US)

(72) Inventors: Ranzell Nickelson, III, Houston, TX (US); James Kendall Mayes, Houston, TX (US); James Lee Prather, Houston, TX (US); Richard Lee Fox, Houston, TX (US); Colin Hendricks, Houston, TX (US)

(73) Assignee: YOUDATA, INC., Houston, TX (US)

(21) Appl. No.: 13/787,364

(22) Filed: Mar. 6, 2013

Related U.S. Application Data
(63) Continuation of application No. 12/580,789, filed on Oct. 16, 2009.

(51) Int. Cl. G06Q 30/02

(52) U.S. Cl. CPC G06Q 30/0273
USPC 705/14.39

(57) ABSTRACT

A method for matching consumers and advertisements over a network includes matching demographic traits provided by the consumers with demographic targets provided by advertisers. Upon receiving a request for a consumer through a website of a web content provider, the central server provides the requesting consumer with a user interface that includes a slide-bar icon with which the requesting consumer can share a portion of the compensation it will receive for viewing that advertisement with the content provider.

This application is a continuation of and claims priority to U.S. patent application Ser. No. 12/580,789, filed Oct. 16, 2009 and entitled “SYSTEM, METHOD AND COMPUTER PROGRAM PRODUCT FOR COMPENSATING WEB USERS FOR VIEWING TARGETED ADS”, which claims priority to U.S. provisional patent application Ser. No. 61/105,885, filed Oct. 16, 2008 and entitled “SYSTEM AND METHOD FOR COMPENSATING USERS FOR VIEWING TEXT AND VIDEO ADS TARGETED BASED ON ANONYMOUS DEMOGRAPHIC DATA”, both of which are hereby incorporated by reference herein in their entireties.

### TECHNICAL FIELD OF THE DISCLOSURE

The present disclosure relates generally to online web advertising and, more particularly, to directly compensating web users for their attention to targeted ads while allowing advertisers to target accurately the viewers of their messages.

### BACKGROUND OF THE DISCLOSURE

Web-based media consumers and advertisers are often thrown together by chance or in haste. As a result, ads often irritate consumers and advertisers are often unhappy with their limited abilities to target specific demographic groups and track the true impact of their messages. These deficiencies and many others generally stem from a core flaw in the advertising ecosystem: the tight coupling of ads to content. That is, advertisers are limited to relying on the nature of the content of a web site, TV show, or radio segment as a very imprecise proxy for the interests of their viewers. Consumers, on the other hand, must sit through often irrelevant, interruptive messages that have no direct value to them.

Banner ads have existed on the Web since its early days in the 1990s but suffer from many insufficiencies. Currently, there are no accurate ways to track the true number of human viewers of banner ads because Web-based bots can easily be created to generate false hits. It can be extremely difficult to target banner ads for specific users.

Conventional online advertising manifests in two forms: banner and video ads targeted to broad audiences on high traffic Web sites, which are similar to TV ads, and context sensitive text ads like Google® AdSense that are chosen for display based on the content of the web page itself. These approaches suffer from the same deficiencies common to all ads since the inception of mass media in the early twentieth century and have even invented some new problems such as click fraud.

One specific problem is that there Is no direct incentive for web surfers and viewers alike to pay attention to any particular ad. Conventional web advertising mechanisms simply follow the traditional compensation model of compensating the content providers for displaying the ads and not the users/viewers who view the ads. They also do not allow advertisers to target their audience accurately. Consequently, advertisers often rely solely on the content of a web site as an imprecise proxy for the interests of the consumer. Moreover, in some cases, the ads can be tracked based on impressions, which are known to be easily manipulated on the Web using automated bots to generate fake impressions.

### SUMMARY OF THE DISCLOSURE

Embodiments disclosed herein can address the aforementioned deficiencies by directly compensating Web users for viewing ads selectively presented to the users based on information about the users. In some embodiments, at least a portion of the information about a user is provided by the user. In some embodiments, Web users are paid for viewing ads. In some embodiments, this is achieved by a proprietary ad tracking software, referred to herein as the YouData™ Ad player or simply the Ad player. In some embodiments, the Ad player resides on a server machine. In some embodiments, the Ad player may be implemented as a client-side application running on a user's computer. In some embodiments, the Ad player may be embedded or otherwise integrated in a publisher's Web site.

In some embodiments, the Ad player may be operable to allow a user to login to their YouData account, track the ads shown to the user, and directly compensate the user. In one embodiment, the user can receive such a payment through their You Data account. In one embodiment, the payment is automatically transferred from their YouData account to a designated account. In one embodiment, the designated account may be a PayPal® account, a bank account, a credit card account, or another online account.

Some embodiments provide a Web site with campaign management features for advertisers and private data management features for viewers of advertising. The campaign management features allow advertisers to target ads to account users with specific traits. Example traits may include, but are not limited to, age, gender, etc. In one embodiment, this can be achieved by enabling advertisers to define ad campaigns that target certain traits. In some embodiments, users can provide their trait data as part of creating their YouData accounts.

In some embodiments, when a user opens the Ad player to view ads, the player sends a request to a YouData server for ad campaigns matching that user's traits. In some embodiments, the server can find all matching campaigns and return a number of ads that offer the highest compensation to the user. In one embodiment, the server may return at least five ads. In some embodiments, after the user viewed an ad, the Ad player may send a subsequent request to the server to move money from the ad campaign of the viewed ad to the user's YouData account. In one embodiment, money in the user's YouData account may be transferred to a designated account as specified by the user. In one embodiment, such a payment transfer may occur instantly or periodically or be triggered by a predetermined threshold.

Some embodiments include a “MeFile™” through which a user can provide basic demographic information about him. In some embodiments, the MeFile can be stored on a server of YouData. The stored MeFile is associated with the user's YouData account, under control of the user, and can be safely and privately accessible by the user through the You Data Web site. Web advertisers can use the YouData web site to create and fund campaigns that target MeFiles having specific trait values.

In some embodiments, the YouData Ad player may be a multimedia and application player that runs the YouData Ad player files containing vector-based objects, including graphics, images, videos, audios, and/or applets of varying degrees of Interactivity and function, allowing many different possible forms of interaction with end users. In one embodiment, these files are in Shockwave® Flash® (SWF) format. In one embodiment, these files are in the W3C open-standard Scalable Vector Graphics (SVG) format. Other suitable file formats are also possible. Once created, these files can be played by the YouData Ad player. In some embodiments, the YouData Ad player may be a standalone player. In some embodiments, the YouData Ad player may be a browser plug-in. In some embodiments, the YouData Ad player may be embedded within the context of a Web page hosted by any Web site,

In some embodiments, a user or an independent Web site owner can configure the YouData Ad player to share ad revenue between the YouData user and the Web site owner. This allows YouData to replace traditional online advertising models with a targeted, accurate and auditable ad serving approach that compensates both the viewers of ads and the Web sites they visit. Web sites no longer need to skew their content to attract users of certain demographics, users finally get paid for their attention, and advertisers get guaranteed delivery of messages to the exact users they aim to reach.

Embodiments disclosed herein can provide advertisers with great power and flexibility in configuring their ad campaigns on the YouData Web site. They can supply ad content in the form of text, images, and video. In addition to providing online tools that allow an advertiser to define a campaign for a certain data range for a combination of demographic traits, the YouData Web site may allow the advertiser to specify a bid signifying a dollar amount they are willing to pay for each ad view. In some embodiments, when a user requests ads through the YouData Ad player, the YouData server can return ads from those campaigns that best match the requesting user's demographic traits as defined in their MeFile. In some embodiments, the YouData server can sort the ads by bid prices and return a list of the highest priced ads to the user through the YouData Ad player, perhaps trimming the list if necessary.

Embodiments disclosed herein can allow media consumers to selectively view certain ads and pay them directly for their attention while allowing advertisers to precisely target ads to certain demographic groups. The consumers are able to control their private information in the form of a MeFile they can manage via the centralized YouData website. This MeFile is never disclosed to advertisers. Advertisers can use the YouData website to centrally manage and customize campaigns that target certain demographic combinations and know that the YouData Ad player guarantees delivery of the ads. This combination of control on the consumer side with respect to which and how many ads they see and what demographic data about them is known, and on the advertisers' side the ability to precisely, and verifiably target ads is a unique advantage provided by embodiments disclosed herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example embodiment of a system architecture;

FIG. 2 depicts a diagrammatic representation of an example embodiment of an advertiser architecture;

FIG. 3 depicts a diagrammatic representation of an example embodiment of a central database storing advertising campaigns each having demographic targets specified by YouData advertisers;

FIG. 4 depicts a diagrammatic representation of an example embodiment of a consumer architecture;

FIG. 5 depicts a diagrammatic representation of an example embodiment of a central database storing MeFiles containing consumer traits specified by YouData consumers;

FIG. 6 depicts a diagrammatic representation of an example embodiment of an ad matching algorithm translatable to match consumer traits specified by YouData consumers with demographic targets specified by YouData advertisers;

FIG. 7 depicts a diagrammatic representation of an example embodiment of a method of compensating users for viewing targeted ads;

FIG. 8 depicts a diagrammatic representation of an example embodiment of a user interface for campaign management;

FIG. 9 depicts a diagrammatic representation of an example campaign created via the campaign management interface of FIG. 8;

FIGS. 10-12 depict diagrammatic representations of example functions of the campaign management interface of FIG. 8;

FIGS. 13A-13D are screenshots, illustrating a method of creating a user account via an example embodiment of YouData Web site;

FIGS. 14A-14D are screenshots illustrating an example embodiment of a user interface for account management via the You Data Web site of FIGS. 13A-13D; and

FIG. 15 depicts a diagrammatic representation of an example embodiment of a YouData Ad player with a slider bar enabled to allow revenue sharing between a consumer and a publisher.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

The disclosure and the various features and advantageous details thereof are explained more fully with reference to the non-limiting embodiments that are illustrated in the accompanying drawings and detailed in the following description. Descriptions of well known hardware and software components, programming languages and programming techniques are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

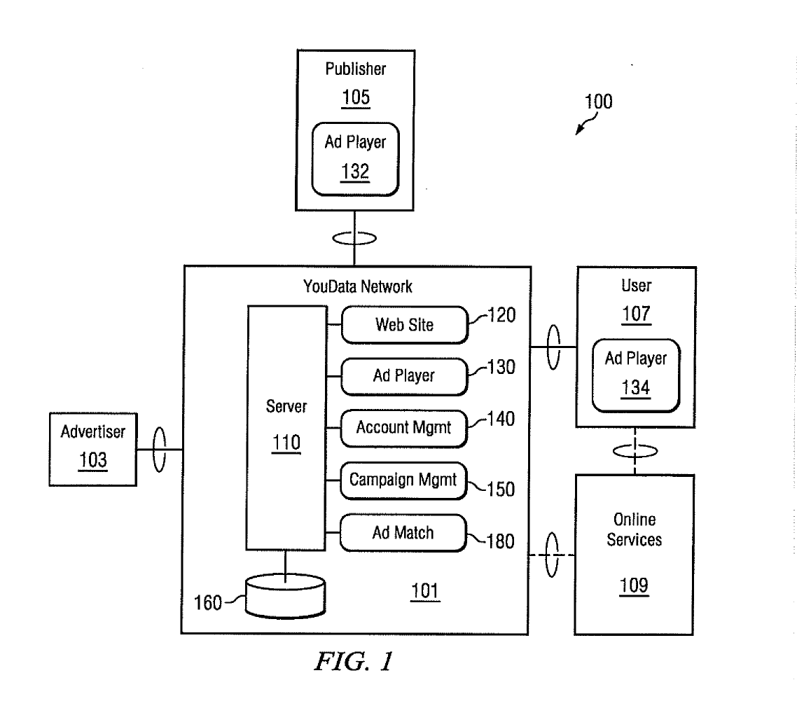

FIG. 1 depicts a diagrammatic representation of an example embodiment of system 100 comprising an enterprise computing environment own and operated by a particular entity named YouData (referred to herein as YouData Network 101), a plurality of providers of Web ads (represented by Advertiser 103), a Web content provider (represented by Publisher 105), and a plurality of consumers who consume/view the Web content (represented by User 107). In some embodiments, system 100 may reside in a distributed computer network. In some embodiments, YouData Network 101 may connect to third party online service providers (represented by Online Services 190). In some cases, User 107 may have one or more accounts with Online Services 190.

YouData network 101 may comprise Server 110 connected to central data storage 160. Those skilled in the art will appreciate that Server 110 and central data storage 160 may be implemented on one or more machines. In some embodiments, Server 110 may comprise at least one processor and a computer program product embodied on one or more computer readable storage media storing computer instructions executable by the at least one processor to implement Web Site 120, Ad player 130, Account Management 140, Campaign Management 150, and Ad Match Algorithm 180. In some embodiments, these components may be implemented as modules. In some embodiments, these components may be implemented as portions of a program. In some embodiments, some of the components may be integrated. For example, Ad player 130 may be embedded within a Web page of Web Site 120 hosted by Server 110. In some embodiments, the computer instructions may be further executable by the at least one processor to implement Ad player 132 and provide same to Publisher 105 in response to a request from Publisher 105. Ad player 132 may be embedded within a Web page of a Web site that is operated by Publisher 105. Ad player 132 may therefore be hosted by an entity independent of YouData. In some embodiments, the computer instructions may be further executable by the at least one processor to provide Ad player 134 to User 107 in response to a request from User 107. Ad player 134 may be installed by User 107 as a desktop/standalone application on a computing device of User 107.

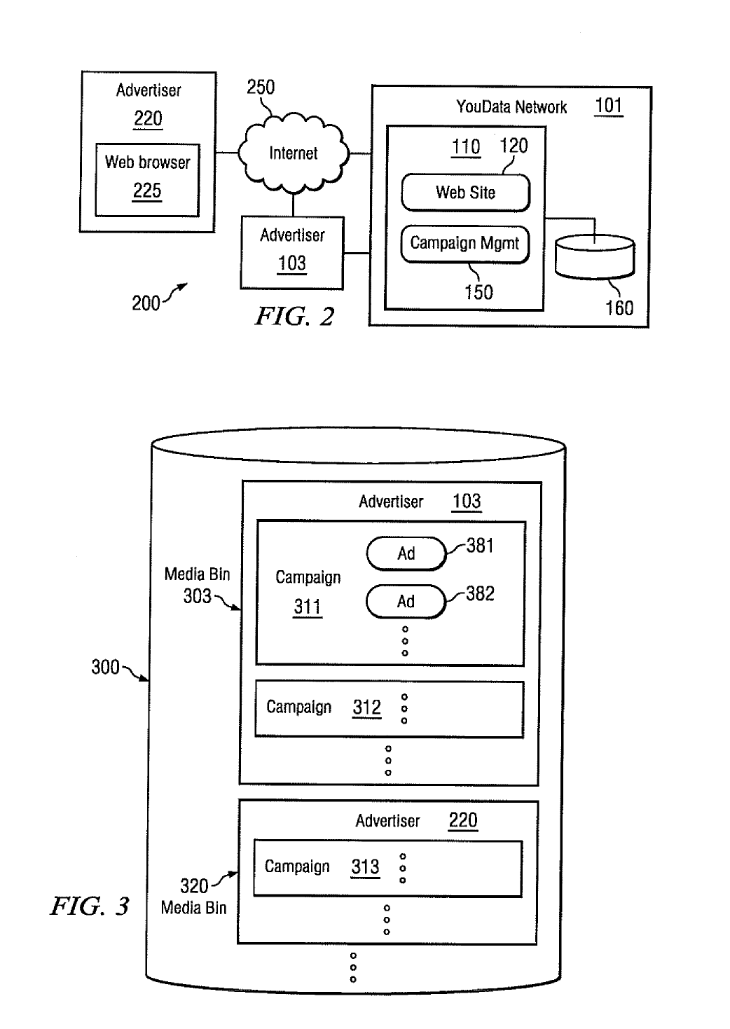

FIG. 2 depicts a diagrammatic representation of an example embodiment of advertiser system architecture 200 illustrating a relationship between YouData and advertisers. Advertiser 103 and Advertiser 220 are representatives of various Web advertisers that may have a contractual relationship with YouData. YouData Network 101 may be connected to Advertiser 220 over Internet 250. YouData Network 101 may provide a Web based interface and functions through which Advertiser 220 can create and manage one or more advertising campaigns. In some embodiments, the Web based interface and functions are provided through Campaign Management 150 within Web Site 120 hosted on Server 110 and accessible by Advertiser 220 via Web browser 225 running on a computing device of Advertiser 220. In some embodiments, YouData Network 101 may be connected to Advertiser 103 in some other ways and may allow Advertiser 103 to create and manage one or more advertising campaigns in a manual or semi-automated manner as known to those skilled in the art. In some embodiments, these campaigns may be centrally stored on storage device 160 accessible by Server 110.

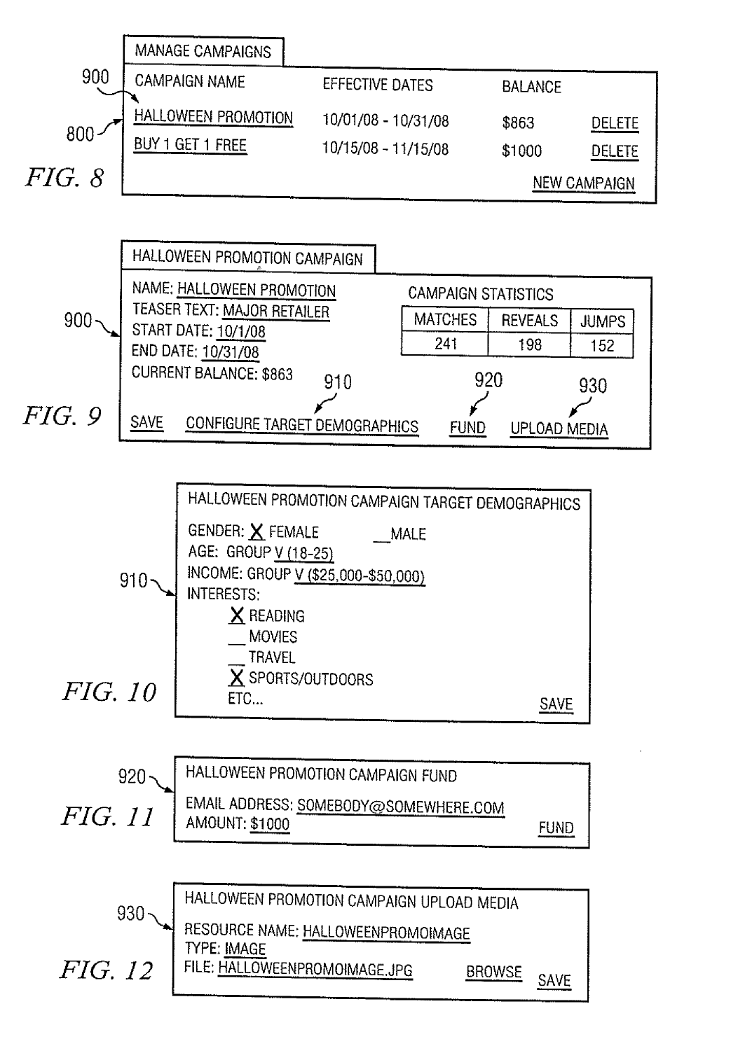

FIG. 3 depicts a diagrammatic representation of an example embodiment of central database 300 storing advertising campaigns each having demographic targets specified by YouData advertisers. In some embodiments, database 300 may reside on storage device 160 and be maintained by Server 110. Database 300 may be a relational database comprising Media Bins 303, 320 associated with Advertisers 103, 220. Each media bin may comprise media pieces associated with campaigns created and/or built by each advertiser. Each campaign may comprise one or more ads. In the example of FIG. 3, Media Bin 303 is associated with Advertiser 103 and stores media pieces associated with Campaigns 311, 312 having Ads 381, 382, etc. and Media Bin 320 is associated with Advertiser 220 and stores media pieces associated with Campaign 313 having its own ads. Example campaigns will be described below with reference to FIGS. 8-12.

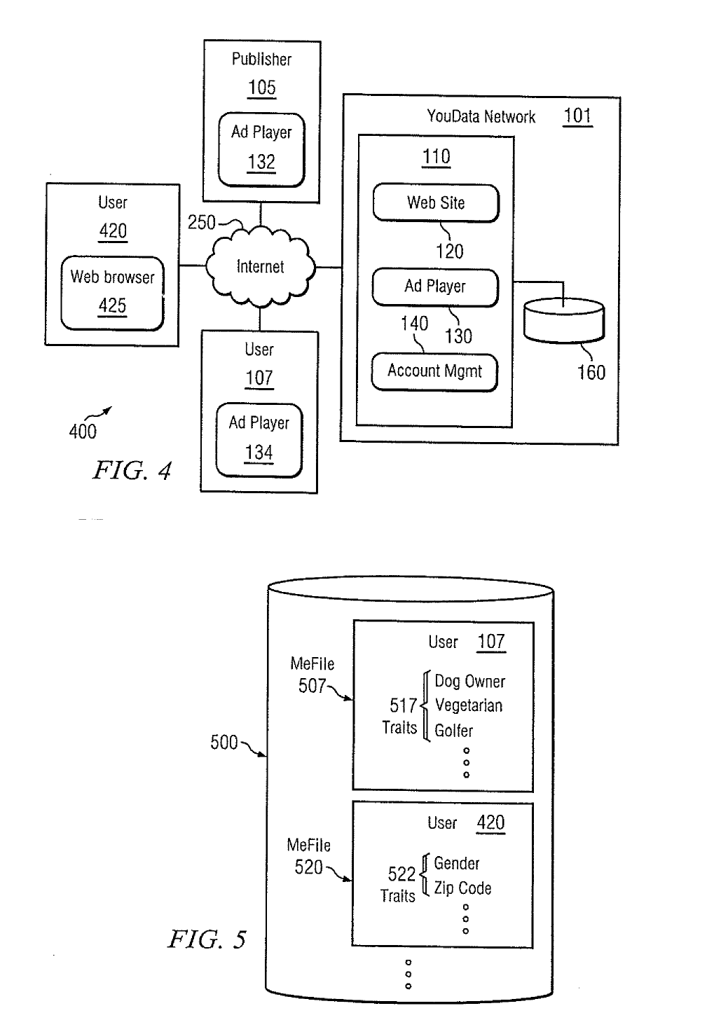

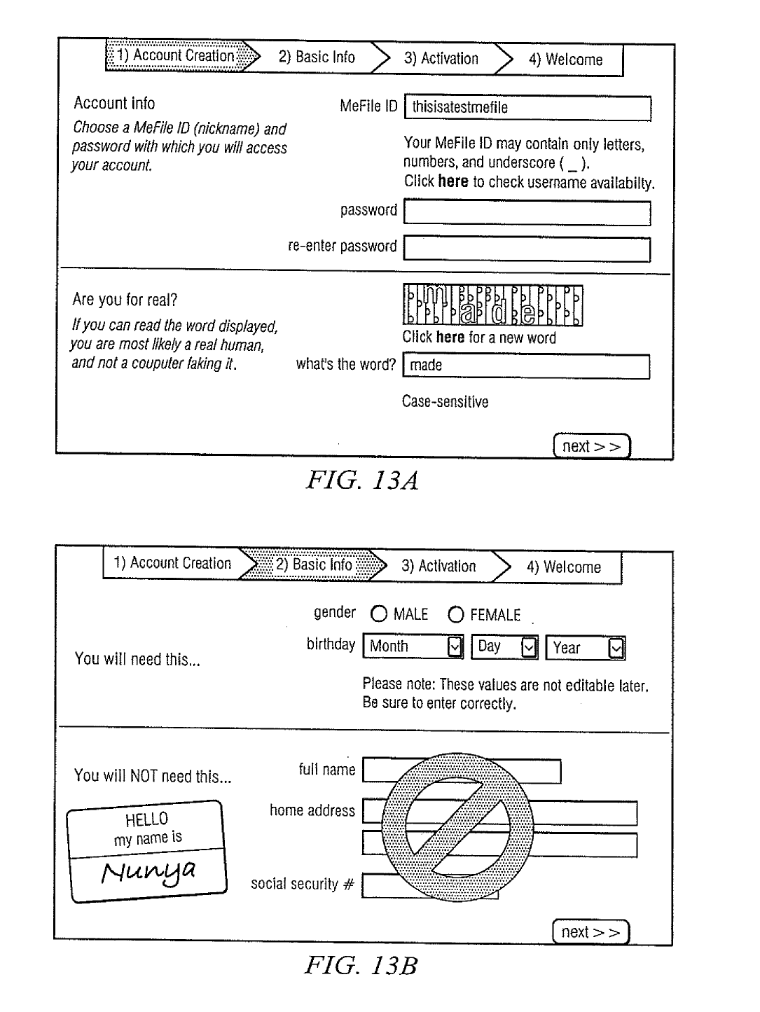

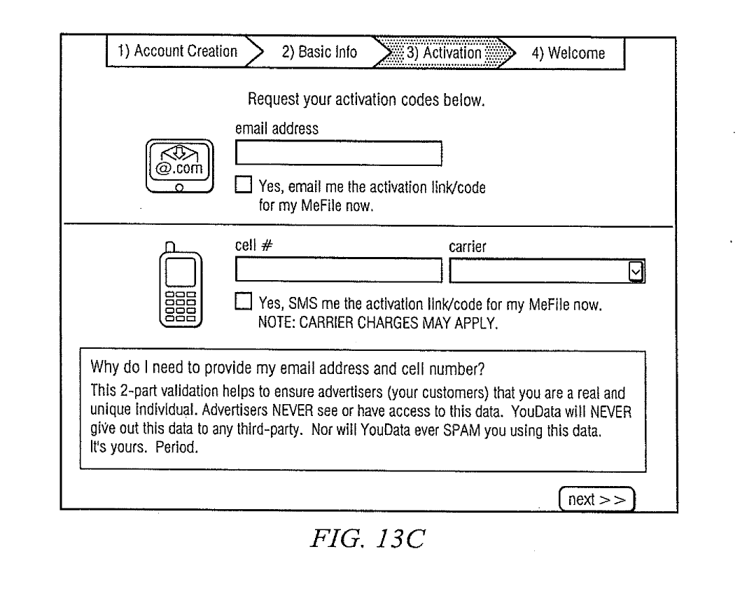

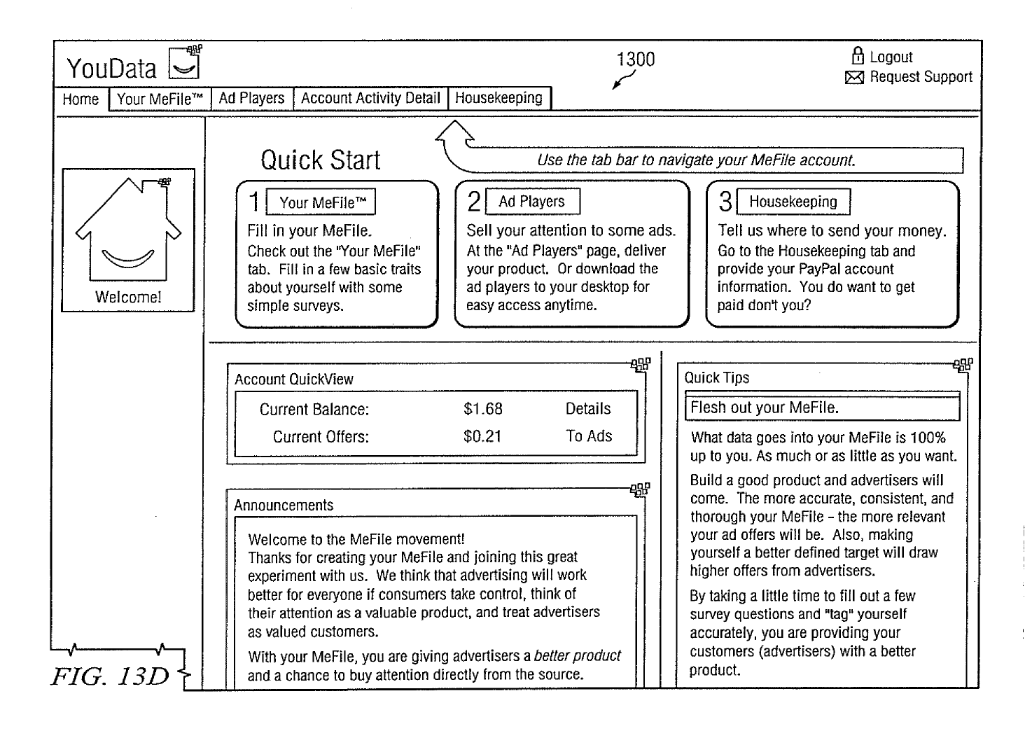

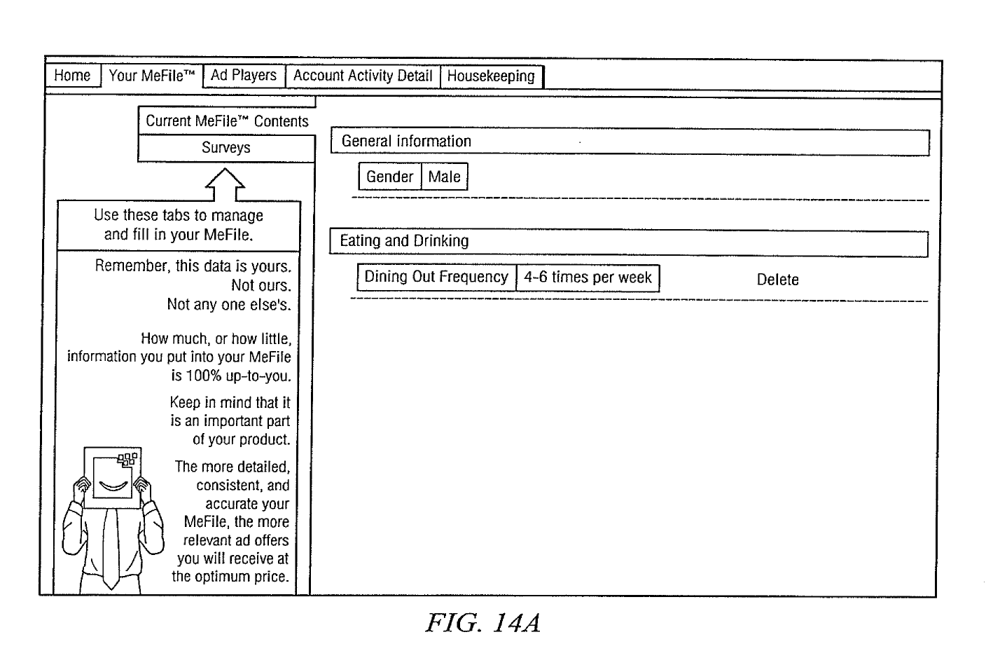

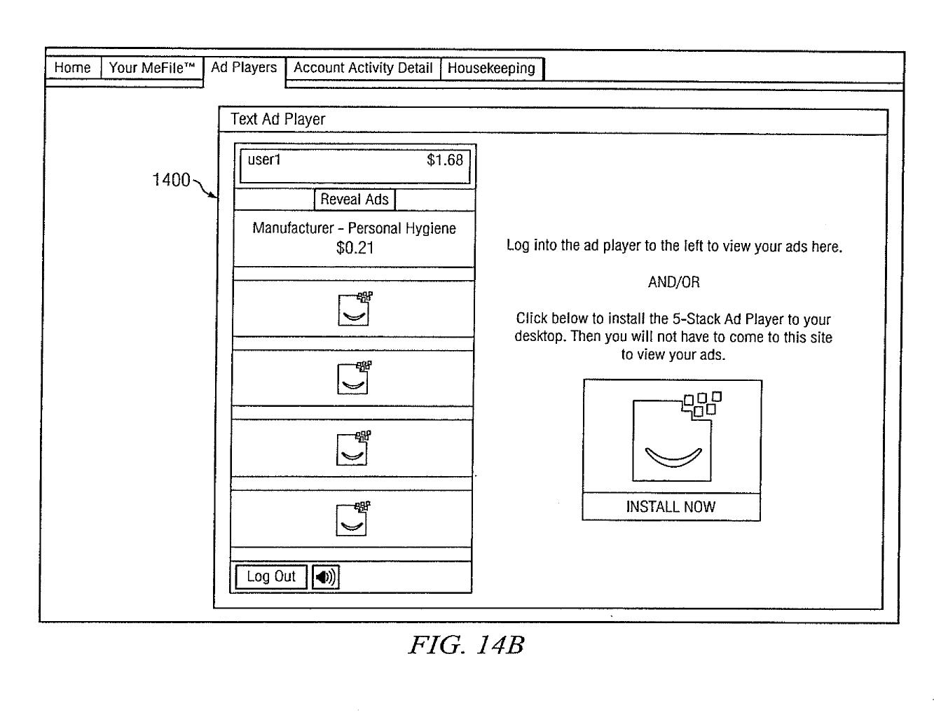

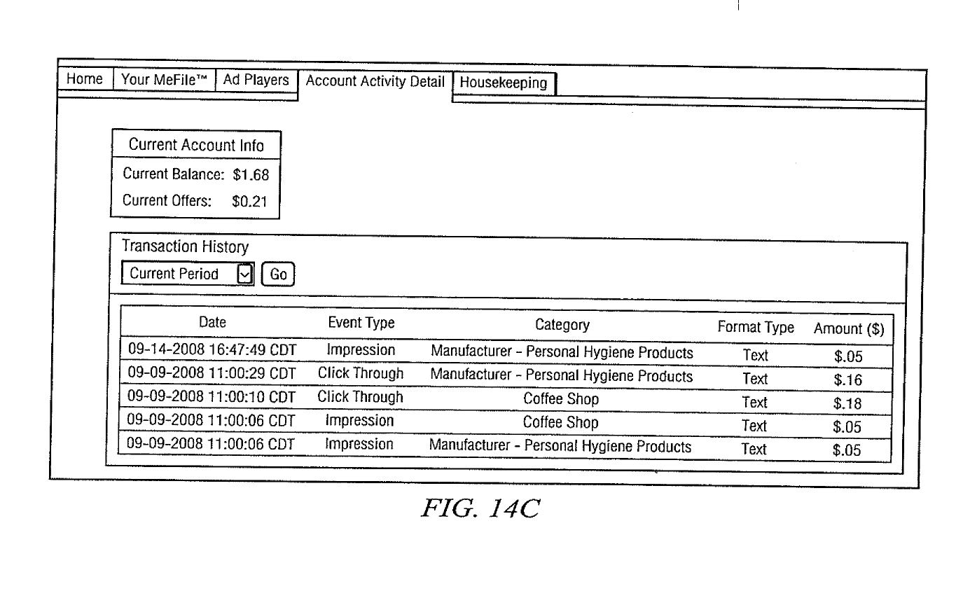

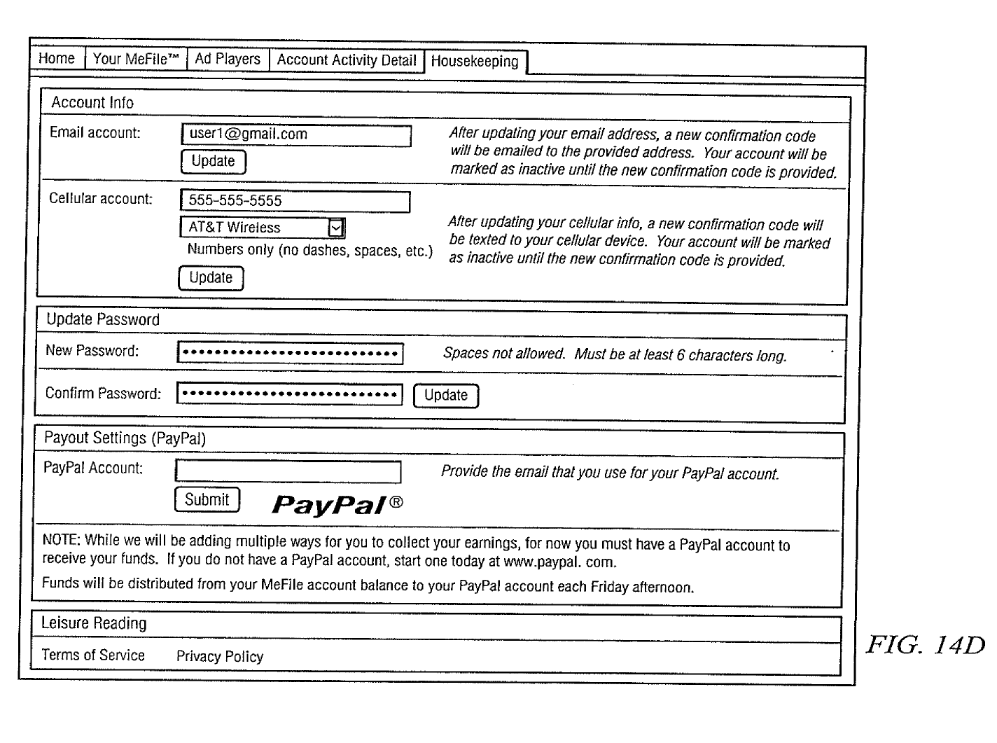

FIG. 4 depicts a diagrammatic representation of an example embodiment of consumer system architecture 400 illustrating a relationship between YouData and consumers. A consumer can create a YouData account via Web Site 120. For example, User 420 may direct Web browser 425 running on a computing device of User 420 to a Web page of Web Site 120 that implements Account Management 140. An example method of creating a user account will be described below with reference to FIGS. 13A-13D. They may also create a “MeFile” via Account Management 140. In some embodiments, a MeFile is a particular type of file stored at a computer readable storage medium or device 160 accessible by Server 110. A MeFile contains a configurable list of demographic traits including, but not limited to, age, sex, income, and interests of a particular consumer. The consumer maintains control of their MeFile content at all times and can update and extend the MeFile content at any time. In some embodiments, YouData may add new attribute/demographic choices to the consumer. An example method of creating a MeFile will be described below with reference to FIG. 14A. FIGS. 14B-14D illustrate example functions provided through Account Management 140 within Web Site 120.

FIG. 5 depicts a diagrammatic representation of an example embodiment of central database 500 storing MeFiles containing consumer traits specified by YouData consumers. In some embodiments, database 500 may reside on storage device 160 and be maintained by Server 110. Database 300 may be a relational database comprising MeFiles 507, 520 associated with Users 107, 420. Each MeFile may comprise traits associated with each individual consumer. In the example of FIG. 5, MeFile 507 is associated with User 107 having Traits 517 and MeFile 520 is associated with User 420 having Traits 522.

In some embodiments, the YouData Ad player is a small Flash application that will run in many different contexts: within a content provider's Web site, within the YouData Web site, or on a consumer's local computer. In the example of FIG. 4, User 107 may launch Ad player 134 installed on their local computing device and User 420 may launch Ad player 132 embedded within a Web page hosted by a Web site of publisher 105 or Ad player 130 embedded within a Web page hosted by Web site 120 of YouData Network 101. In all of these contexts, the YouData Ad player may ask the user for their user ID and password or may load it automatically from a cookie stored locally on their computer. In some embodiments, the YouData Ad player sends this login information via the Hypertext Transport Protocol over Secure Sockets Layer (HTTPS) to the YouData server. In some embodiments, the YouData Ad player sends this login information to the YouData server over a local network. The YouData server may operate to authenticate the user ID, look up the traits in their MeFile and run the YouData ad matching algorithm to return a list of ads targeted specifically at that user's demographic traits. All of this communication can occur over standard web protocols as known to those skilled in the art and will not be interfered with by routers or firewalls.

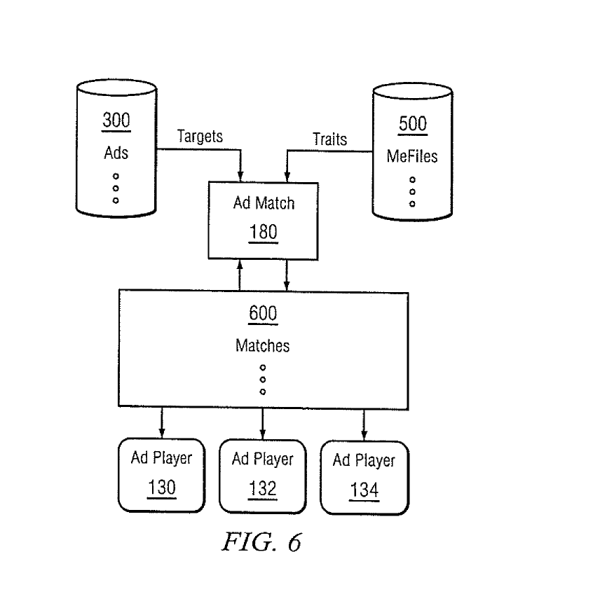

FIG. 6 depicts a diagrammatic representation of an example embodiment of an ad matching algorithm translatable to match consumer traits specified by YouData consumers with demographic targets specified by YouData advertisers. As discussed above, advertisers can create and manage advertising campaigns which are centrally stored and accessible by the YouData server. Each campaign may include ad media, effective dates, demographic targets, bidding rules and a funding amount (and potentially other data). For example, Campaign 311 may comprise a set of campaign rules, target demographic information, and media files for Ads 381, 382. Ad 381 may be associated with a media sequence and a bid price. This media sequence may dictate the order of certain media pieces to be played for Ad 381. The bid price may indicate an amount of money that Advertiser 103 is willing to bid in order to have Ad 381 placed on top or in front of other ads that might be competing for the consumer's attention. As will be described below, this bid price is separate from and in addition to the price that Advertiser 103 has agreed to pay the consumer for viewing Ad 381.

Also as discussed above, consumers can create and manage their MeFiles which are centrally stored and accessible the YouData server. Each MeFile may contain traits of a particular consumer specified by that consumer. In some embodiments, Ad Match 180 may comprise code translatable to implement a plurality of functions, including, but not limited to, accessing databases 300 and 500, matching user traits from MeFiles for all the YouData consumers with targets from advertising campaigns of all the YouData advertisers, placing the matches in central queue 600, querying central queue 600 to pull a portion of the matches, dynamically creating offers for users having traits that match the targets, sorting the offers based on the bid price associated with each ad, providing the offers to Ad player(s) for presenting the ads to the users, tracking viewing of the ads by the users, managing the funds for the advertisers, and paying those users who actually viewed the ads. In some embodiments, Ad Match 180 may implement some of these functions.

The matching algorithm that pairs MeFiles with specific targeted ads takes into consideration several data dimensions, including: consumer traits provided in the MeFile; the number of times a single MeFile account has received the same ad/offer; and the freshness of any trait (the day entered/created) involved in the proposed match between ad and consumer. The matching engine takes a general pool of candidate matches, and procedurally eliminates MeFiles for the pool as additional matching criteria are applied. As ads are matched to MeFiles using all the criteria provided by the advertiser; matches are pre-populated and persisted in a database table containing each MeFile's offer queue. From this persisted set of matches and offers, the Ad players can pull the appropriate number of ads to be presented.

As a specific example, referring to FIG. 5, MeFile 507 for User 107 contains Traits 517 which include “Dog Owner,” “Vegetarian,” and “Golfer.” Ad Match 180 may find one or more advertising campaigns that target “Dog Owner,” “Vegetarian,” “Golfer,” or any combination of these demographic groups. Referring to FIG. 3, suppose Campaign 311 targets dog owners, Campaign 312 targets vegetarians, and Campaign 313 targets golfers who are also vegetarian. Because the target demographics of these campaigns match the traits of User 107, Ad Match 180 may determine to generate offers for User 107 to view ads from these campaigns. Each offer may include a teaser description of a particular ad from a matching campaign, a link to the ad or to a network address provided by the advertiser of the campaign, and an amount that the advertiser is will to pay User 107 for viewing the ad.

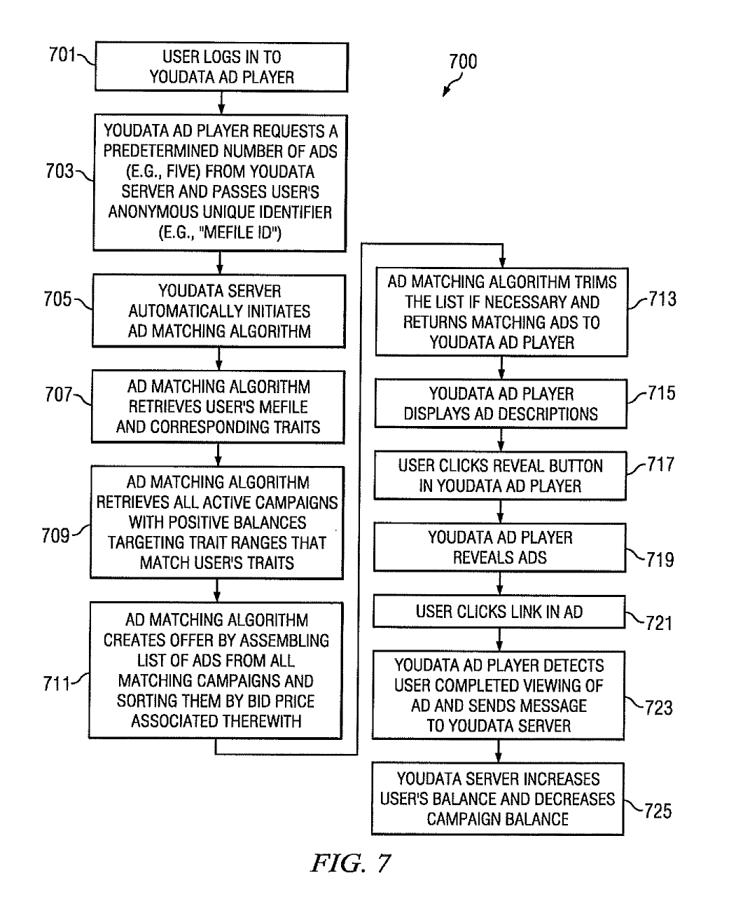

FIG. 7 depicts a diagrammatic representation of an example embodiment of a method of compensating users for viewing targeted ads. In some embodiments, method 700 may be realized through software components running on Server 110 as discussed above with reference to FIG. 1. In this example, a user may log in to a YouData Ad player (701). The YouData server may receive a request for ads from the YouData Ad player containing the username of the user and some optional Input parameters (703). In some embodiments, these optional parameters may include a content provider's Web site hosting the Ad player and a split percentage for the ad revenue. The server may initiate an ad matching algorithm in response to the request from the Ad player (705).

The ad matching algorithm may load the user's traits from their MeFile (707). In some embodiments, this information is loaded from the YouData database running within the same datacenter as the YouData Web site. The ad matching algorithm then looks in the database for active ad campaigns targeting the user's traits (709). For example, a representative of a clothing store might create a back-to-school campaign with a text and graphic ad targeted at young women and might specify that the back-to-school campaign runs for the month of August, pays 20 cents per reveal, 10 cents per URL jump, and has a total budget of $1000. The ad matching algorithm may match the ad to female users of the chosen age range for the month of August or until the $1000 budget is exhausted. In some embodiments, the campaigns may have defined rules that designate ranges of acceptable values or bid prices for certain traits. In some embodiments, ads within the same campaign may have same or different values. In some embodiments, media pieces associated with the same ad may have same or different values. The ad matching algorithm may build a list of all the ads that match the user's traits and orders the list by price in descending order to maximize the revenue opportunity for the user (711). The ad matching algorithm returns this list of ads to the Ad player for display to the user (713).

The YouData Ad player receives the list of targeted ads and their prices from the server and presents same to the user (715). For example, the user might see “Restaurant/Food $0.31” indicating an ad for a restaurant that will result in a 31 cent credit to their YouData account. The user can then choose to press the Reveal Ads button in the player (717), which will cause the player to reveal the ads (719). In some embodiments, text ads, video ads, or a combination thereof may be shown. Each ad may contain text, graphic(s), hyperlink(s), or a combination thereof to the advertisers' Web site. In some embodiments, once an ad is revealed, the user's YouData account may be instantly credited and the content of the ad is revealed. The user is then presented with the opportunity to jump to the advertiser's website and collect more credit (721). If the user chooses to do so, a new browser window or tab is opened and pointed to the uniform resource locator (URL) address specified by the advertiser. In some embodiments, the user's YouData account may not be credited until the ad is fully displayed. For example, if a video ad is 30 seconds long, the Ad player may determine whether all 30 seconds of the ad had been played/viewed and provide the viewing information to the server (723). The server may credit the user's account by the amount associated with the ad and deduct that from the campaign fund associated with the ad.

In one embodiment, when the user's YouData account balance reaches a certain minimum threshold or on a configurable schedule, the YouData server may automatically initiate a transfer of the user's YouData balance or a portion thereof to a designated account as specified by the user. An example of a designated account may be a PayPal® account, a bank account, a credit car account, or another online account.

FIG. 8 depicts a diagrammatic representation of an example embodiment of user interface 800 for campaign management 150. As discussed above, advertisers can create and manage ad campaigns via the YouData Web site. To do this, they first create a YouData account on the YouData Web site. The YouData Web site includes a Web page where advertisers having accounts with the YouData Web site can create ad campaigns. Through functionalities provided through this Web-based interface 800, YouData advertisers can name a new campaign, configure/edit the duration of a campaign, mark a campaign as active, or delete an old campaign.

FIG. 9 depicts a diagrammatic representation of example campaign 900 created via campaign management interface 800. FIGS. 10-12 depict diagrammatic representations of various features of example campaign 900. More specifically, YouData advertisers can configure target demographics by selecting from choices similar to what YouData consumers would face when building their MeFile (910). In some embodiments, the advertisers may specify the acceptable value ranges of specific traits of users that should see the ads. In some embodiments, YouData advertisers may fund the campaign with a real-time submission of money from an online account (920). An example of an online account is a PayPal® account. In some embodiments, YouData advertisers may fund the campaign with a check. In one embodiment, YouData may also provide human campaign consultants to provide advice to YouData advertisers on the best way(s) to construct advertising campaigns. In some embodiments, YouData advertisers may also upload the media files for the ad(s) (930). Example media may include, but are not limited to, images, video, sounds, text, etc.

FIGS. 13A-13D are screenshots, illustrating by example how a user account may be created via an example embodiment of YouData Web site. Those skilled in the art will appreciate that other ways to create user accounts are also possible. In some embodiments, once a user creates and activates a YouData account, the user can begin to build his or her own MeFile. In this example, after logging in the user is provided with a plurality of navigation tabs 1300 comprising “Home,” “You MeFile™,” “Ad players,” “Account Activity Detail,” and “Housekeeping.” Navigation tabs 1300 may represent an example embodiment of a Web-based user interface for account management such as Account Management 140 described above with reference to FIG. 1.

FIG. 14A-14D are screenshots illustrating example navigation tabs “You MeFile™,” “Ad players,” “Account Activity Detail,” and “Housekeeping.” For example, a Web page associated with the “You MeFile™” tab may provide sub tabs of functions with which the user may manage and fill in his or her own MeFile, as Illustrated In FIG. 14A. A Web page associated with the “Ad players” tab may provide the user with one or more embedded Ad players. In the example of FIG. 14B, Text Ad player 1400 operates to present a teaser description of a personal hygiene manufacturer's ad to user “user1”, along with a value of 21 cents associate with viewing the ad. In this example, use “user1” has a balance of $1.68. Should user “user1” decide to view the ad by selecting the “Reveal Ads” button, his account may be instantly credited, increasing the balance by 21 cents to $1.89. A Web page associated with the “Account Activity Detail” tab may provide further details, including transaction history, on the user's account, as illustrated in FIG. 14C. A Web page associated with the “Housekeeping” tab may provide additional housekeeping functions and/or information related to the user's account, as illustrated In FIG. 14D.

Referring to FIG. 4, Publisher 105 may use Web site 120 to create a content provider account. Web site 120 may generate a unique identifier for Publisher 105. Publisher 105 can then place Ad player 132 on their Web site and pass the identifier to Ad player 132 as part of the tags within the HTML page that host Ad player 132. In one embodiment, Ad player 132 is implemented as a Flash application. When ads are viewed using this instance of the YouData Ad player, the unique YouData identifier for the particular content provider is sent to the Server 110 along with the Publisher 105's ID and the ad view data. A portion of the revenue is then credited to Publisher 105's YouData account and automatically paid to them. In one embodiment, the payment is made when the balance reaches a configurable minimum or on a configurable interval.

In some embodiments, the ad revenue can be split between a user and a content provider. This can be done in various ways. In some embodiments, the content site hosting the player in their pages may configure the player to always pay them a certain percentage of each ad viewed. This payment may be placed in an account they created with YouData (via YouData.com) and transferred to them on a scheduled basis. In some embodiments, the YouData Ad player may be configured to display a sliding bar to the user, allowing the user to voluntarily allocate a percentage of their ad money to the hosting Web site, In one embodiment, this could be used as a kind of tip jar for the site or as a way to give a charitable donation to a site. In practice, a user may visit a Web site and login to the YouData Ad player hosted there. The YouData Ad player may present ads and also a slider bar to the user, allowing the user to designate from 0 to 100% of the ad revenue to the Web site hosting the YouData Ad player. When the YouData Ad player submits the ad view data to the YouData server, it passes along the split percentage to the server. The YouData server then allocates the ad revenue between the user's account and the content provider's account according to the split percentage. The ad money then flows from the ad campaign to the user and to the content provider according to that percentage.

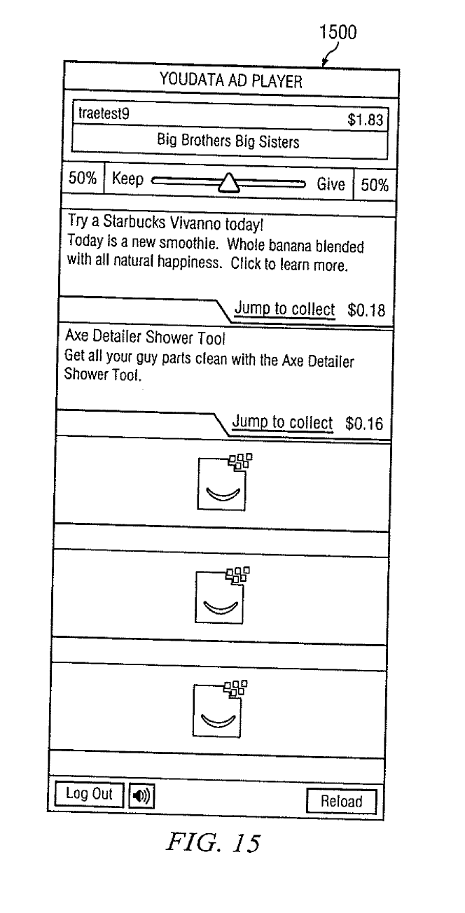

FIG. 15 depicts a diagrammatic representation of an example embodiment of YouData

Ad player 1500 with a slider bar enabled to allow revenue sharing between a consumer and a content provider. In this case, consumer “traetest9” has a current balance of $1.83 and YouData Ad player 1500 offers consumer “traetest9” to view two ads, sorted by their respective values of 18 and 16 cents. YouData Ad player 1500 is embedded within a Web page of a Web site for charity “Big Brothers Big Sisters.” The built-in slider bar enables consumer “traetest9” to split 50-50 any ad money received with charity “Big Brothers Big Sisters.”

In some embodiments, the total cost to a YouData advertiser for an ad may be the sum of the amount that the advertiser is willing to pay a consumer for viewing the ad (i.e., the ad money received by the consumer), plus a fixed fee to YouData, and a bid price for a chance to get to the front of the list created and maintained by You Data. In some embodiments, this bid price may be a percentage of the ad money. As a specific example, suppose Advertiser 103 is willing to pay User 107 20 cents for viewing Ad 381 and YouData 101 charges Advertiser 103 a fixed fee of 10 cents for Ad 381. Advertiser 103 places a bid of 20% of 20 cents, making the total cost of Ad 381 to be 34 cents.

When a consumer views an ad or chooses to jump to an advertiser's site (by selecting a link provided by the Ad player), a portion of the total cost of the ad flows from the advertiser's campaign fund to the consumer's account. In some cases, a portion may also go to a publisher's account. YouData keeps a small fraction of each transaction for providing all of the functionality described above, including the ability for consumers to control of their demographic information (traits) contained in MeFiles. An example MeFile may comprise a user profile and tags that are built by a surveying campaign or any suitable collection mechanism. Although traits are tagged, MeFiles are not tracked or logged. The individual demographic information never reaches the advertisers. Because the central database for advertisers utilizes the same data structure as the central database for consumers, the ad matching algorithm described herein can compare tags and find matches effectively and efficiently without revealing the identities of individual consumers.

As described above, the ad matching algorithm may place the matches in a queue. Depending upon implementation, the ad matching algorithm may match ad targets with consumer traits and generate offers right away or later. For example, the generation of an offer may be triggered by the creation of a new campaign, by the creation of a new MeFile, or by a predetermined time interval. When a consumer logs into his YouData account, the YouData server may query the queue to pull only those offers linked to the consumer's MeFile. In some embodiments, not all matches are offered to the consumer as there can be many. In some embodiments, a maximum of five ads may be selected from the matches, perhaps based on their bid prices, and offered to the consumer.

Embodiments disclosed herein provide a controlled conduit to sell anonymous demographic information to Web advertisers while providing Web advertisers a precise method for targeting campaigns to certain demographic groups. Additionally, content providers who host the YouData Ad player may be compensated with a portion of the ad revenue stream, allowing content providers to participate in the ad revenue generated in association with their content. The YouData Ad player may also provide the consumer with the opportunity to split their ad revenue with the content provider, which may be their favorite blog or charity, in the form of a slider bar on the YouData Ad player, allowing them to allocate a portion of their revenue to the content provider.

Embodiments of a system, method, and computer program product for compensating Web users viewing targeted ads have now been described. Although the invention has been described in detail herein with reference to the illustrative embodiments, it should be understood that the description is by way of example only and is not to be construed in a limiting sense. It is to be further understood, therefore, that numerous changes in the details of the embodiments disclosed herein may be made without departing from the spirit and scope of the disclosure, and may be made by persons of ordinary skill in the art having reference to this description. Accordingly, the scope of this disclosure should be determined by the following claims and their legal equivalents.

1. A method for matching consumers and advertisements over a network and compensating the consumers for viewing the advertisements, comprising:
providing a central advertiser database and a separate central consumer database accessible locally by a central server in a computing environment;
a plurality of advertisers connected to the computing environment accessing the central advertiser database over the network;
each advertiser providing to the central advertiser database at least one advertising campaign including at least one advertisement and one or more demographic targets for each advertisement;
storing the advertising campaigns in the central advertiser database;
a plurality of consumers connected to the computing environment accessing the central consumer database over the network;
each consumer submitting demographic traits about the consumer to the central consumer database;
creating and storing a user file in the central consumer database for each consumer, each user file including the demographic traits provided by the respective consumer;
matching demographic traits in the user files with demographic targets in the advertising campaigns and creating a central queue of matching advertisements;
the central server receiving a request for matching advertisements submitted by a consumer thereto through a website of a web content provider accessible over the network;
the central server identifying the matching advertisements from the central queue for the requesting consumer;
for each matching advertisement on the list, the central server associating an amount of compensation to which the consumer is entitled for viewing the advertisement;
the central server providing the requesting consumer with a user interface that includes a list of the matching advertisements by topical category and amount of compensation for viewing such advertisement and a button the user can select to reveal the matching advertisements;
upon the requesting consumer selecting the button to reveal the matching advertisements, the central server providing, on the user interface, each matching advertisement and a slide-bar icon with which the requesting consumer can share a portion of the compensation it will receive for viewing that advertisement with the content provider, the slide-bar icon having a button movable by the requesting consumer along a scale of 0-100%; and
the requesting consumer allocating a specific percentage of the compensation it will receive for viewing an advertisement to the web content provider by moving the button on the slide-bar icon to the appropriate position on the scale, wherein the requesting consumer determines the specific percentage to be shared at its sole discretion.

2. The method of claim 1 further including
after the requesting consumer selects the button to reveal the matching advertisements, the central server providing a link to the website of the advertiser of each matching advertisement, and
upon the requesting consumer selecting the link to the advertiser of a matching advertisement, the central server providing the requesting consumer with additional compensation.

3. The method of claim 1 further including
the central server providing a video to the requesting consumer as part of the matching advertisement, the video being viewable by the requesting consumer, and
the central server compensating the requested consumer for viewing the video advertisement when the entire duration of the video has been viewed by the requesting consumer.

4. The method of claim 1 further including
preventing any access by the advertisers to the central consumer database and data contained therein, wherein the advertisers cannot receive or view the user files on the consumer database or data contained therein.

5. The method of claim 4 further including matching demographic traits in the user files with demographic targets in the advertising campaigns and creating a central queue of matching advertisements by
accessing the user file of each consumer in the consumer database,
searching the advertiser database for advertising campaigns having one or more demographic target that matches at least one of the demographic traits in each user file,
building the central queue of matching advertisements and user files, and
storing the central queue in a database table.
